(19) United States
(12) Patent Application Publication
(10) Pub. No.: US 2008/0309917 A1
(43) Pub. Date: Dec. 18, 2008

(54) Optical Short-Range Sensor

(75) Inventors: Uwe Zimmermann, Remseck (DE); Michael Weilkes, Sachsenheim (DE); Achim Pruksch, Neudenau (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/793,665

(22) PCT Filed: Nov. 22, 2005
(86) PCT No.: PCT/EP2005/056129

§ 371 Date: Apr. 4, 2008

(30) Foreign Application Priority Data
Dec. 23, 2004 (DE) 10 2004 062 022.9

(51) Int. Cl. G01S 13/91

(52) U.S. Cl. 356/5.01

(57) ABSTRACT

In an optical short-range sensor, a plurality of sequentially actuatable transmission elements (21 . . . 27) disposed in a line-like manner in one plane is provided. At least one additional transmission element (1) situated offset in relation to the sequentially actuatable transmission elements and in particular transmitting downward, is provided. In a receiver device (3), the signals reflected by objects are evaluated in particular by propagation time measurement.

### BACKGROUND INFORMATION

The present invention relates to an optical short-range sensor, in particular for motor vehicle applications. Sensor systems which are suitable for a plurality of functions, e.g., a 24 GHz pulse radar sensor system for implementing blind spot detection (BSD) and parking space measurement (PSM) are known for implementing driver assistance functions.

### SUMMARY OF THE INVENTION

It is possible to implement a universally usable short-range sensor for different driver assistance functions by applying the measures of claim 1, i.e., using a plurality of transmission elements that are disposed in a line-like manner in one plane and are sequentially actuatable, in particular in a pulse-shaped manner, at least one additional transmission element which is offset in relation to the sequentially actuatable transmission elements and which in particular transmits downwards, a receiver device for the common evaluation of signals of the transmission elements reflected by objects, by propagation time measurement in particular. The sensor according to the present invention is equally suitable for the functions blind spot detection and parking space measurement. The parameters which are of particular importance for PSM such as passing distance from parked vehicles, precise location determination of the vehicle edges, and detection of the curb including measurement of the passing distance are detected reliably. The same sensor may be used at another installation site, e.g., at the front or rear instead of a side area of the motor vehicle for other functions as well, e.g., short-range coverage, lane detection, traffic jam assistance, etc. A modular design makes it possible to adjust the sensitivity or the used distance range according to the application, e.g., by replacing the module of the transmission elements (replacement of high-quality transmission elements such as laser diodes with IREDs or LEDs or a combination of high-quality transmission elements and transmission elements of low optical performance).

In contrast, the control electronics or the receiver device may be used for all applications. Assemblies for other sensors/sensor groups may be used or included for use in control electronics, such as the delay circuit for SSR (short-range radar) sensors. The different transmission elements may be optimally coordinated with one another for the particular application. In addition or as an alternative, a variation of the light intensity of the transmission elements may be provided for the various applications by varying the pulse width of the control pulses.

The other claims indicate additional advantageous embodiments.

### BRIEF DESCRIPTION OF THE DRAWINGS

Exemplary embodiments of the present invention will be elucidated in greater detail below with reference to the drawing.

FIG. 1 shows a front view of the short-range sensor according to the present invention,

FIG. 2 shows a top view,

FIG. 3 shows a side view,

FIG. 4 shows a block diagram of the sensor,

FIG. 5 shows a detection field of a sensor,

FIG. 6 shows the replacement of a transmission module.

### DESCRIPTION OF THE EXEMPLARY EMBODIMENTS

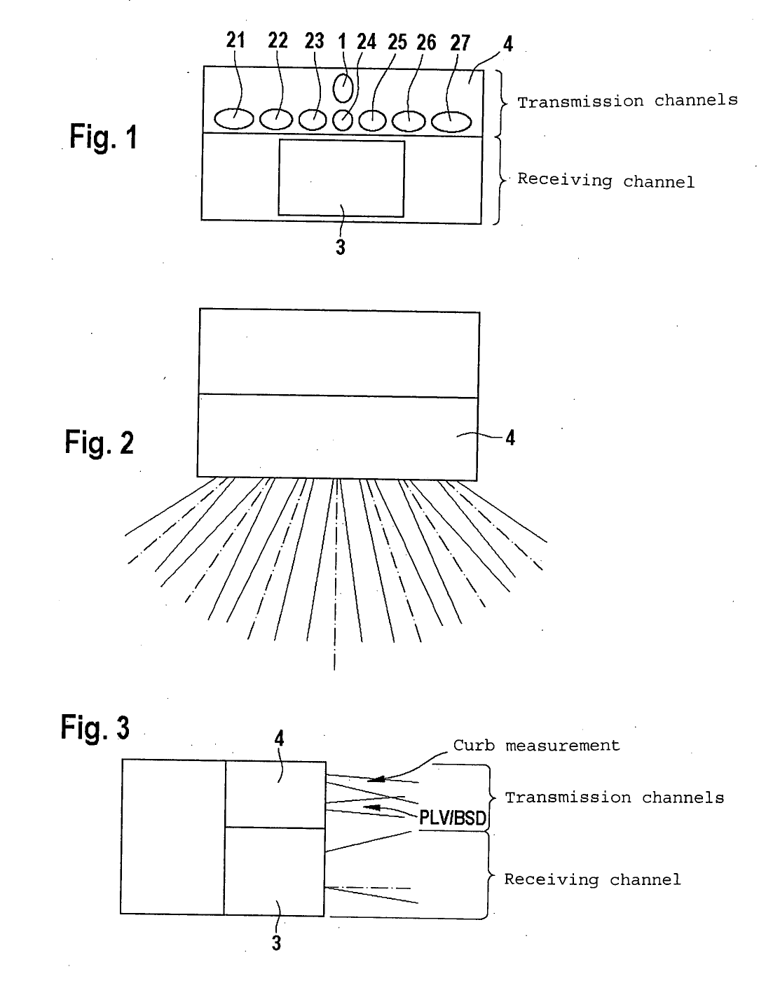

The sensor concept shown in FIGS. 1 through 3 is based on a plurality of economical optical transmission elements 1, 21, 22, 23, . . . 27, which, with the exception of transmission element 1, are disposed in a line-like manner in one plane. They are offset from one another so that their transmission beams illuminate a wide angular range in the shape of a fan (FIG. 2). Additional transmission element 1 is located on the center axis of transmission elements 21 . . . 27 disposed in a line-like manner, specifically above them in another plane. Transmission elements 21 . . . 27 disposed in a line-like manner are sequentially actuated using pulse-shaped signals in particular. Additional transmission element 1 may also be actuated by pulse-shaped signals. For detecting objects by propagation time measurement, a receiver device 3 is used, whose reception range covers the entire transmission range (horizontally and vertically). Receiver device 3 is located in the lower area of the sensor. A common evaluation of the received signals occurs, i.e., evaluations are made from the correlations of the received signals for different applications such as blind spot detection (BSD), parking space measurement (PSM), etc.

The sensor geometry shown in FIG. 1 makes angularly resolved distance measurement possible primarily using the seven transmission beams in a lateral direction for BSD. In addition to blind spot detection, the central beam of transmission element 24 is also used for parking space measurement (PSM). Curb detection or shoulder marking is primarily performed using a beam of transmission element 1 directed downward, the beam geometry of which is adapted to typical passing distances. If the optical systems are installed properly and due to the relatively short measuring range (<−14 m), no significant reduction in performance is expected due to soiling and spray. It is possible to design the system in such a way that possible soiling is detected as such.

The transmission beam of transmission element 1 may of course be used for other evaluations, for example as a redundancy element for verifying less reliable detection.

While simple transmission elements such as LEDs or infrared emission diodes (IREDs) may be used for the sequentially actuatable transmission beams, a highly optimized receiving channel is used for receiver device 3 because the receiving elements are less economical than the transmission elements. The use of silicon PIN diodes instead of avalanche photodiodes (APD) may, for example, eliminate the necessity of generating high voltage for the operation of the APD. Higher quality laser diodes (LD) may also be used instead of IREDS, in particular for greater ranges.

A modular design makes it possible to replace the transmission module as a function of the range and geometry requirements of the function. Standard components/assemblies may be used in addition to the transmission and receiving elements, e.g., optical filters, lenses, evaluation electronics. Using an indirect propagation time measurement adapted to LIDAR, i.e., using a coincidence evaluation of a correspondingly delayed transmission pulse reflected by an object (see DE 199 63 005 A1), makes it possible to use or include for use essential concepts of the SSR (short range radar) pulse radar if such assemblies are also installed in the motor vehicle.

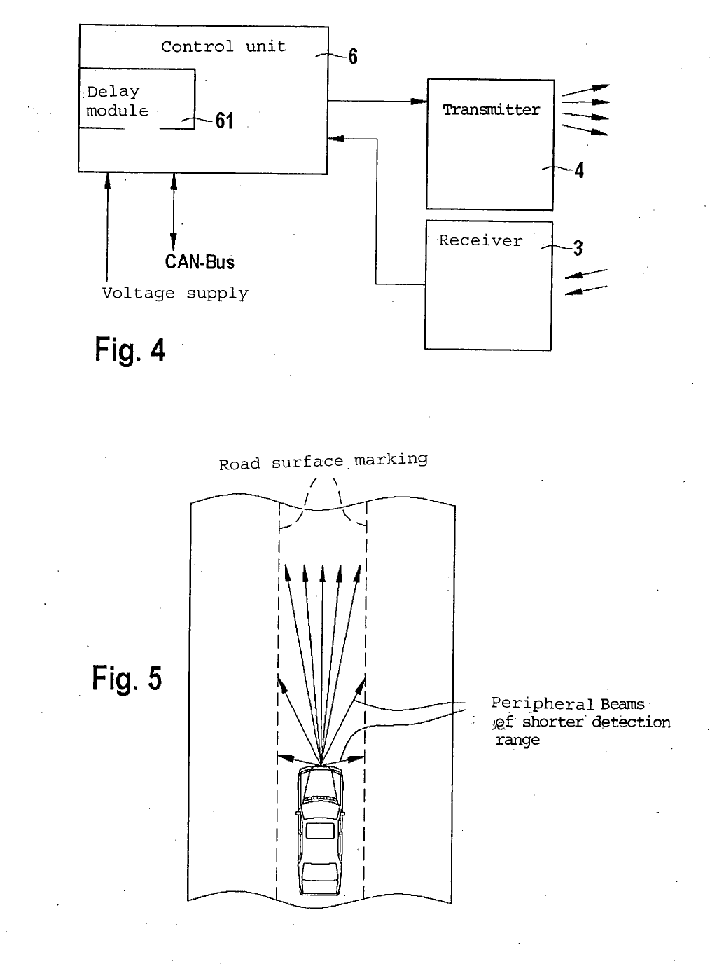

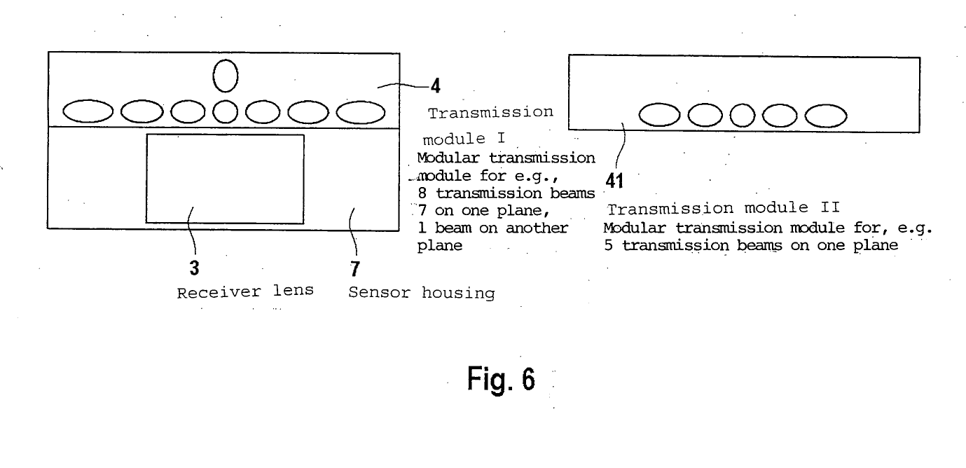

FIG. 4 shows a block diagram of a modular sensor designed according to the present invention and FIG. 6 shows its accommodation in a housing 7. Transmission module 4, receiver device 3 and control unit 6 are accommodated in a common housing 7. Depending on the intended function, transmission module 4 may be replaced with another module 41 without changes to the housing being necessary.

In FIG. 4, assembly 61 is integrated in control unit 6 for the delay of the transmission signal from the SRR radar technology.

A detection field including nine individual beams for a sensor according to the present invention is shown in FIG. 5. The peripheral beams have significantly shorter ranges than the central beams. For this scenario, laser diodes may be used, for example, as transmission elements for the central beams and simple LEDs or IREDs for the peripheral beams. One advantage of a shorter range of the peripheral beams is that non-relevant objects such as structures on the roadside are not detected, which results in advantages for signal evaluation and processing in particular. Simple scalability is achieved as a result of the modularity of the transmitter structure.

In the case of the reflectors occurring in road traffic, the dynamic range of useful light intensities to be detected covers approximately 8 powers of ten. This dynamic range may be implemented, for example, on the receiver side by switching different amplification stages, and on the transmitter side by influencing the light intensity, e.g., of an IRED via the current flowing through and also by varying the pulse width of a propagation time-measuring optical system. It is of particular advantage to vary the transmission power by changing the pulse duration of the transmission pulses. Varying the pulse width is more economical to implement than regulating the current of the transmission components. Amplification and attenuation stages in the receive signal path may be completely eliminated. The advantage is that the distance of objects having high intensity is automatically measured more accurately because the pulse duration for reducing the light intensity is diminished. This means that close objects reflecting more strongly in the normal case are measured more accurately than more distant ones. This is compatible with a typically required relative measuring accuracy with reference to distance. If an IRED or laser diode (LD) is actuated by pulses, the default pulse width corresponding to a specific value, the transmitted light intensity may be reduced/increased within specific limits by shortening/lengthening the pulse width. At the same time, the accuracy of the distance determination is changed in a propagation time-measuring optical measuring system by changing the pulse width. This is based on the fact that the pulse width directly influences the resolution. Short pulses result in pulses having narrow half widths; long pulses result in larger half widths. The peak positions of narrower pulses may be determined more accurately than the wider pulses. When replacing transmission elements with varying degrees of sensitivity, the pulse width variation may also be used to implement an adaptation to the intended function.

1-12. (canceled)

13. An optical short-range sensor for a motor vehicle, comprising:
a plurality of sequentially actuatable transmission elements, the sequentially actuatable transmission elements being disposed in a line-like manner in one plane and being sequentially actuatable in a pulse-shaped manner;
at least one additional transmission element which is offset in relation to the sequentially actuatable transmission elements, and which transmits downward; and
a receiver device adapted for common evaluation of signals of the sequentially actuatable transmission elements and the at least one additional transmission element reflected by objects, by propagation time measurement.

14. The short-range sensor as recited in claim 12, wherein the sequentially actuatable transmission elements and the at least one additional transmission element are situated in a replaceable module which is accommodated in a common housing together with the receiver device.

15. The short-range sensor as recited in claim 13, wherein the sequentially actuatable transmission elements are offset from one another in such a way that their transmission beams illuminate a wide angular range in a fan-like manner.

16. The short-range sensor as recited in claim 13, wherein the additional transmission element is situated on a center axis of the sequentially actuatable transmission elements, above the sequentially actuatable transmission elements.

17. The short-range sensor as recited in claim 13, wherein a central one of the sequentially actuatable transmission elements is adapted for parking space measurement.

18. The short-range sensor as recited in claim 13, wherein the additional transmission element is adapted for curb detection.

19. The short-range sensor as recited in claim 13, wherein the sequentially actuatable transmission elements are adapted for blind spot detection.

20. The short-range sensor as recited in claim 13, wherein the sequentially actuatable transmission elements are optical transmission elements, the optical transmission elements including at least one of LEDs, laser diodes, and infrared emission diodes, depending on a range.

21. The short-range sensor as recited in claim 13, wherein the receiver device includes PIN diodes or avalanche photodiodes.

22. The short-range sensor as recited in claim 13, further comprising:
a common control electronics adapted to at least one of: i) actuate at least one of the sequentially actuatable transmission elements and the at least one additional transmission element, and ii) evaluate via receiving elements;
wherein the control electronics are based at least partially on assemblies provided for other sensors or sensor groups in the motor vehicle.

23. The short-range sensor as recited in claim 22, wherein the control electronics includes a delay circuit for an SRR (short-range radar) sensor for coincidence evaluation.

24. The short-range sensor as recited in claim 13, wherein a variation of a pulse width of the actuation pulses is provided for varying a the light intensity of the sequentially actuatable transmission elements and the at least one additional transmission element.

25. The short-range sensor as recited in claim 13, further comprising:
a device adapted to detect soiling of at least one of the sequentially actuatable transmission elements and the receiving element.
